(19) United States
(12) Patent Application Publication
(10) Pub. No.: US 2010/0329380 A1
(43) Pub. Date: Dec. 30, 2010

(54) METHOD FOR SELECTING ADAPTIVE FREQUENCY BASEBAND OF WALSH CODES, ADAPTIVE FREQUENCY-SELECTIVE SPREADER USING THE SAME AND TRANSMITTING AND RECEIVING APPARATUS USING THE ADAPTIVE FREQUENCY-SELECTIVE SPREADER

(75) Inventors: Tae-Wook Kang, Daejeon (KR); In-Gi Lim, Daejeon (KR); Sung-Weon Kang, Daejeon (KR); Hyung-Il Park, Daejeon (KR); Chang-Hee Hyoung, Daejeon (KR); Jung-Hwan Hwang, Daejeon (KR); Jin-Kyung Kim, Daejeon (KR); Jung-Bum Kim, Daejeon (KR); Sung-Eun Kim, Seoul (KR); Kyung-Soo Kim, Daejeon (KR); Ki-Hyuk Park, Daejeon (KR); Jae-Hoon Shim, Daejeon (KR)

Correspondence Address: AMPACC Law Group, PLLC;LOADING..., 6100 219th Street SW, Suite 580, Mountlake Terrace, WA, 98043, US

(73) Assignee: Electronics and Telecommunications Research Institute, Daejeon (KR)

(21) Appl. No.: 12/865,329

(22) PCT Filed: Jan. 30, 2009
(86) PCT No.: PCT/KR09/00438

§ 371 Date: Jul. 29, 2010

(30) Foreign Application Priority Data
Feb. 1, 2008 (KR) 10-2008-0010867
Jun. 16, 2008 (KR) 10-2008-0056362

(51) Int. Cl. H04B 15/00; H04L 25/49; H04L 27/06

(52) U.S. Cl. 375/285; 375/296; 375/340

(57) ABSTRACT

There is provided a human body communication method and system using a frequency-selective baseband in order to transmit and receive data between communication devices that are coupled to a human body by using the human body as a communication channel. The human body communication method and system may be useful to maximize an efficiency of the frequency-selective spreading technology to enhance a processing gain of the Walsh code technology, and thus to reduce the interference between human bodies of users by adaptively selecting a frequency band of Walsh codes that are used for data communications according to the human body channel characteristics and the noise environments that are varied according to the ambient environments, and also construct a low-power and stable human body communication when there is a strong interference induced from other electronic equipments.

### TECHNICAL FIELD

The present invention relates to an adaptive frequency-selective spreader using a frequency-selective baseband in a communication system using a human body as a medium, and a transmitting and receiving apparatus using the same, and more particularly, to a method for selecting an adaptive frequency band of Walsh codes from limited frequency bands according to the channel characteristics and noise environments, the adaptive frequency band of Walsh codes being used for data communications, and the limited frequency bands excluding a frequency band from DC to 5 MHz in which a noise power around a human body is more concentrated in the other frequency bands but including a frequency band in which a signal transmitted through a human body that functions as a wave guide has a higher intensity than a signal emitted from the human body, an adaptive frequency-selective spreader using the same and a transmitting and receiving apparatus using the adaptive frequency-selective spreader.

### BACKGROUND ART

Human body communication is referred to as a technology of transmitting signals between devices that are coupled to a human body having conductivity by using the human body as a communication channel. In this case, communications between various portable devices such as a personal digital assistant (PDA), a portable personal computer, a digital camera, an MP3 player and a mobile phone, and communications with fixed devices such as a printer, TV and an entry control system can be implemented through simple contact with a user.

As prior art relating to the human body communication methods, there have been proposed technologies using a limited pass band and methods using such as scrambling, channel coding, interleaving and spreading, using a user's unique ID.

However, the human-body communication methods have drawbacks in an aspect of low power consumption since most of the communication systems require analog transmitter and receiver terminals such as a digital-analog converter, an analog-digital converter and the like to use a limited frequency band.

Also, the human-body communication methods have drawbacks in that it is ineffective to stably transmit and receive data due to the human body channel characteristics and the ambient noise environments.

### DISCLOSURE OF INVENTION

### Technical Problem

The present invention has been made to solve the foregoing problems of the prior art, and therefore an aspect of the present invention is to provide a method for selecting a suitable frequency spreading band according to human body channel characteristics and ambient noise environments in frequency-selective baseband transmission technologies or frequency-selective Walsh code technologies, an adaptive frequency-selective spreader using the same, and a transmitting and receiving apparatus using the adaptive frequency-selective spreader.

Also, another aspect of the present invention is to provide an adaptive frequency-selective spreader capable of being driven at low power consumption while employing a limited frequency band for stable communications when there is a strong interference induced from other electronic equipment, as well as for not interfering with each other under a communication environment in which a plurality of users exist, and, and a transmitting and receiving apparatus using the adaptive frequency-selective spreader.

### Technical Solution

According to an aspect of the present invention, there is provided a method for selecting an adaptive frequency baseband of Walsh codes that are used for data communications in a human-body communication system, the method including: setting an offset input value to 0; generating a plurality of Walsh code groups by dividing the total 2^{N} Walsh codes used for frequency spreading by a number of 2^{M}; receiving (N−M) frequency-selective control bits to select one of a plurality of the Walsh code groups; receiving M data bits and N counter bits to repeatedly transmit 2^{M} Walsh codes of the selected Walsh code group as many as predetermined cycles; and receiving indexes of the selected 2^{M} Walsh codes by measuring performances of the respective 2^{M} Walsh codes in a plurality of the transmitted Walsh code groups.

In this case, the performances of the transmitted 2^{M} Walsh codes may be measured using a bit error rate (BER) or a frame error rate (FER).

Also, the indexes of the selected 2^{M} Walsh codes may include either a start index, or some or all indexes.

According to another aspect of the present invention, there is provided an adaptive frequency-selective spreader using a frequency-selective baseband, including an N-bit counter unit outputting N counter bits; an adaptive frequency baseband selector receiving M data bits, (N−M) frequency-selective control bits and offset input bits to select a desired frequency band; a gray indexing unit gray-indexing the (N−M) frequency-selective control bits and the M data bits; an arithmetic logic unit performing a logic arithmetic operation on the N counter bits and output bits of the gray indexing unit; and an output unit receiving output bits of the arithmetic logic unit to select output bits.

In this case, the adaptive frequency baseband selector may be a subtracter for offsetting the indexes of the selected Walsh codes to select the desired frequency band.

Also, the gray indexing unit may include (N−1) exclusive OR arithmetic operators (XOR).

In addition, the arithmetic logic unit may include each of N AND arithmetic operators (AND) inputting N counter bits, the most significant bits of (N−M) frequency-selective control bits, and output bits of the (N−1) exclusive OR arithmetic operators (XOR).

Additionally, the output unit may include one exclusive OR arithmetic operator (XOR) inputting output bits of the N AND arithmetic operators (AND).

According to still another aspect of the present invention, there is provided a transmitting apparatus for a human-body communication physical layer modem using an adaptive frequency-selective baseband, including a preamble and header generator generating a preamble for frame synchronization and a header including control information on data to be transmitted; a data generator outputting the data to be transmitted as serial data; a scrambler scrambling the serial data outputted from the data generator; a serial-to-parallel converter converting the scrambled serial data into M parallel data bits and outputting the converted M parallel data bits; an adaptive frequency-selective spreader selecting one of a plurality of Walsh code groups generated by dividing the total 2^{N} Walsh codes used for frequency spreading by a number of 2^{M}, and outputting 2^{M} Walsh codes of the selected Walsh code group; and a multiplexer multiplexing the generated preamble, the header and the selected 2^{M} Walsh codes into digital signals and transmitting the multiplexed digital signals.

In this case, the transmitting apparatus may periodically transmit pre-set Walsh codes between transmitting and receiving apparatuses to the receiving apparatus before or after the initiation of communication of data to determine channel characteristics and ambient noise environments in order to adaptively select a frequency band of the Walsh codes used for frequency spreading.

Also, the transmitting apparatus may repeatedly transmit the pre-set Walsh codes as many as predetermined cycles in order to determine the channel characteristics.

In addition, the adaptive frequency-selective spreader may include an N-bit counter unit outputting N counter bits; an adaptive frequency baseband selector receiving M data bits, (N−M) frequency-selective control bits and offset input bits to select a desired frequency band; a gray indexing unit gray-indexing the (N−M) frequency-selective control bits and the M data bits; an arithmetic logic unit performing an AND logic arithmetic operation on the N counter bits and output bits of the gray indexing unit; and an output unit receiving output bits of the arithmetic logic unit to select output bits.

Additionally, the preamble and header generator may include a preamble generator set to an initial value to generate a preamble having a predetermined length, the initial value being set to acquire frame synchronization; a header generator constructing a header having a pre-set header format, which includes the control information on data to be transmitted; an HCS generator generating a header check sequence (HCS) using the control information having the header format; and a spreader spreading the generated preamble and header.

According to yet another aspect of the present invention, there is provided a receiving apparatus for a human-body communication physical layer modem using an adaptive frequency-selective baseband, including a frame synchronizer detecting a preamble from the transmission data transmitted from a transmission block to perform frame synchronization; a demultiplexer separating a header and data from the transmission data according to the frame synchronization and outputting the separated header and data; a header processor dispreading the separated header, followed by restoring the control information on data through a header check sequence (HCS) testing; an adaptive frequency-selective spreader calculating a correlation value between the separated data and Walsh codes in one Walsh code group, and determining index values of the Walsh codes having the highest correlation value to output corresponding M-bit parallel data, the one Walsh code group being selected from a plurality of Walsh code groups generated by dividing the total 2^{N} Walsh codes used for frequency spreading by a number of 2^{M}, and the Walsh codes in the one Walsh code group being used for spreading of the transmission block; a parallel-to-serial converter converting the M-bit parallel data into serial data and outputting the converted serial data; a descrambler descrambling the serial data into orthogonal codes; and a data processor processing the descrambled data.

In this case, the receiving apparatus may periodically receive pre-set Walsh codes between transmitting and receiving apparatuses from the transmission block before or after initiation of the communication of data, and measures performances of the received Walsh codes to determine channel characteristics and ambient noise environments in order to adaptively select a frequency band of the Walsh codes used for frequency spreading.

Also, the receiving apparatus may select the Walsh codes that are most suitable for the channel characteristics and the ambient noise environments by measuring the performances of the received Walsh codes using a bit error rate (BER) or a frame error rate (FER).

In addition, the receiving apparatus may select the Walsh codes that are most suitable for the channel characteristics and the ambient noise environments, and allot indexes to the selected Walsh codes to transmit either a start index, or some or all indexes to the transmission block.

### ADVANTAGEOUS EFFECTS

In accordance with the present invention, when a frequency-selective baseband transmission method using the data serial-to-parallel conversion and frequency-selective Walsh codes is applied to a conventional human body communication system, it is possible to effectively obtain a processing gain of a Walsh code technology by adaptively selecting a frequency band of Walsh codes according to the human body channel characteristics and the noise environments that may be varied according to the time and spaces.

Also in accordance with the present invention, it is possible to achieve a low-power and stable human body communication by employing a frequency spreading technology of selecting a limited frequency band while avoiding interference between human bodies of users that may be varied according to the time and spaces and strong interference induced from other electronic equipments.

### BRIEF DESCRIPTION OF DRAWINGS

FIG. 1 is a graph illustrating the relations between a frequency-selective baseband for human-body communication according to one exemplary embodiment of the present invention, and a signal power transmitted through a human body, a radiation power emitted from the human body and a noise power around the human body, all of which are varied according to the frequencies.

FIG. 2 is an illustrative diagram illustrating a 64-bit Walsh code according to one exemplary embodiment of the present invention.

FIG. 3 is a block diagram illustrating an adaptive frequency-selective spreader using a frequency-selective baseband in a human-body communication system according to one exemplary embodiment of the present invention.

FIG. 4 is a detailed block diagram illustrating the adaptive frequency-selective spreader as shown in FIG. 3.

FIG. 5 is a flowchart illustrating a method for selecting a frequency band of Walsh codes that are suitable for data communications according to channel characteristics and noise environments according to one exemplary embodiment of the present invention.

FIG. 6 is a block diagram illustrating a transmitter/receiver for human-body communications to which the present invention can be applied.

### BEST MODE FOR CARRYING OUT THE INVENTION

Hereinafter, exemplary embodiments of the present invention that may be easily put into practice by a person having ordinary skills in the art to which the present invention pertains will now be described in detail with reference to the accompanying drawings. However, in describing operations of the exemplary embodiments in detail, when it is considered that a detailed description on related well-known functions or constitutions unnecessarily may make essential points of the present invention be unclear, the detailed description will be omitted.

Also, in the drawings, the same reference numerals are used throughout to designate the same or similar components.

According to one exemplary embodiment of the present invention, a method for adaptively selecting a frequency baseband of Walsh codes according to channel characteristics and noise environments, an adaptive frequency-selective spreader using the same and a transmitting and receiving apparatus using the adaptive frequency-selective spreader may apply to a digital communication system, particularly a human body communication system using a human body as a medium. Therefore, the present invention will be described in more detail relating to the human body communication system.

First, the frequency-selective baseband transmission method refers to a transmission technology that may perform a baseband transmission of analog transmission/reception blocks whose configurations are simple, and obtain a desired frequency band and a processing gain simultaneously by allowing a user to use only Walsh codes, which have the most dominant frequency characteristics at a desired frequency band, out of all Walsh codes that are used to obtain a processing gain of data.

Therefore, the frequency-selective baseband transmission method according to one exemplary embodiment of the present invention is a novel transmission technology that may effectively obtain a processing gain in the Walsh code technology by adaptively selecting a frequency band of Walsh codes according to the human body channel characteristics and noise environments due to the interference between users that may be varied according to the time and spaces and strong interference induced from other electronic equipments.

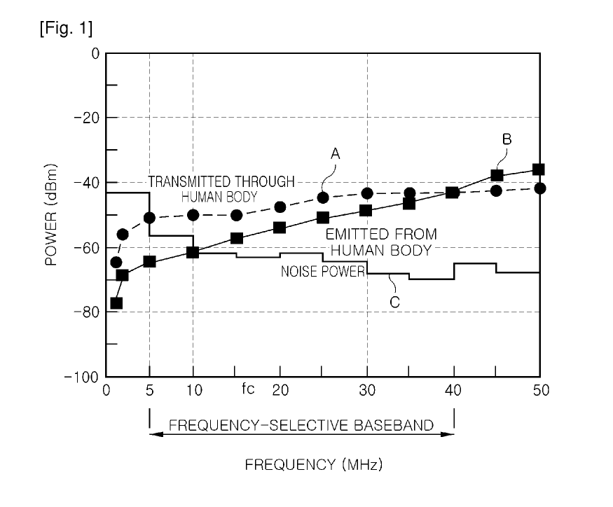

FIG. 1 is a graph illustrating the relations between a frequency-selective baseband for human-body communication according to one exemplary embodiment of the present invention, and a signal power transmitted through a human body, a radiation power emitted from the human body and a noise power around the human body, all of which are varied according to the frequencies.

As shown in FIG. 1, it might be seen that a signal power A transmitted through a human body is dominant over a radiation power B emitted from the human body when a frequency band used for human body communications is in a range from 0 to 40 MHz, but the radiation power B is increased more than the signal power A when the frequency band exceeds 40 MHz.

Also, it is revealed that a noise power C, which is calculated by adding measured values of interference signals induced from various test spaces and dividing the sum total by 5 MHz, is dominant over the signal powers within a frequency band of 0 to 5 MHz.

Therefore, a frequency-selective baseband is used to transmit data within a limited frequency band of 5 to 40 MHz in the present invention, except for the frequency bands of 0 to 5 MHz and greater than 40 MHz at which the highest noise power appears.

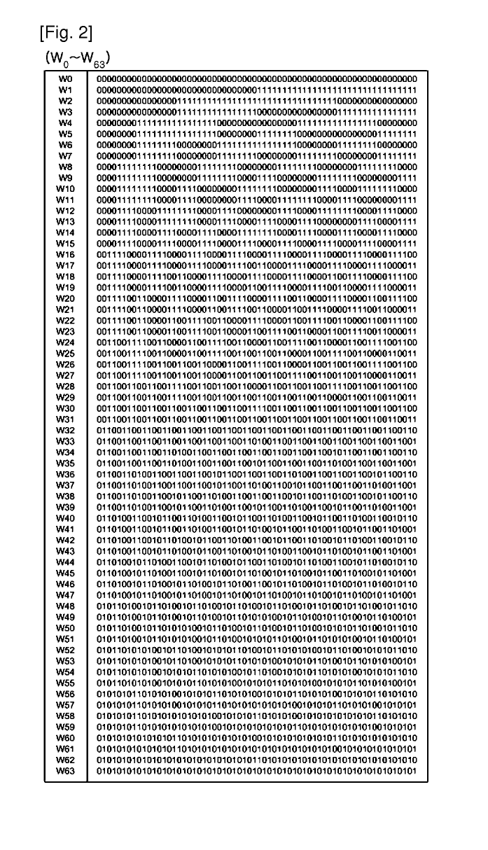

FIG. 2 is an illustrative diagram illustrating a 64-bit Walsh code according to one exemplary embodiment of the present invention.

As shown in FIG. 2, the present invention is characterized in that 64 Walsh codes are used as the Walsh codes, and the 64 Walsh codes spanning from W₀ to W₆₃ function to exactly divide a used frequency band into 64 frequencies and sequentially mapping the most dominant frequency (fd) in each of the Walsh codes into the divided frequencies.

For example, assume that a spreading frequency band of the total Walsh codes is 16 MHz, the most dominant frequency (fd) in each of the Walsh codes has a band gap of 250 KHz (=16 MHz/64).

Therefore, fds of W₀, W₁, W₄₈, and W₆₃ have band gaps of 0 Hz, 250 KHz, 12 MHz, and 15.75 MHz, respectively.

The Walsh codes as shown in FIG. 2 are illustrated as one exemplary embodiment of the present invention, and the frequency-selective Walsh codes are not restricted to the Walsh code composed of 64 bits, but it is possible to use a Walsh code having 2̂K (K is a positive integer) bits.

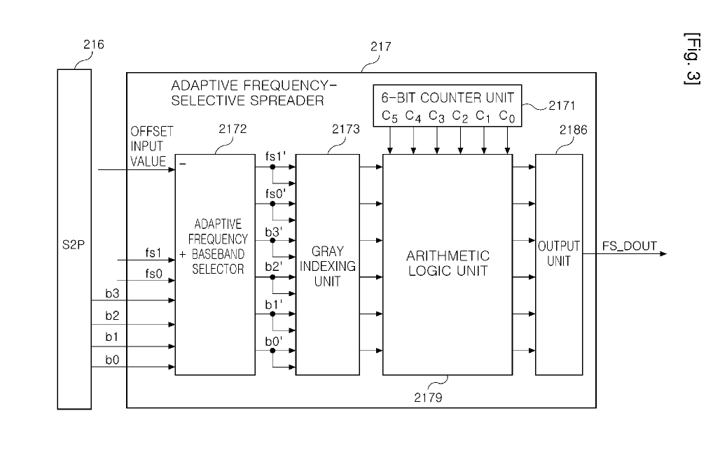

FIG. 3 is a block view illustrating an adaptive frequency-selective spreader for adaptively selecting a frequency-selective baseband of Walsh codes according to the channel characteristics and noise environments according to one exemplary embodiment of the present invention.

First, the adaptive frequency-selective spreader according to one exemplary embodiment of the present invention receives M-bit data input bits, and adaptively selects one in a plurality of Walsh code groups using (N−M) frequency-selective control bits and offset input bits, the plurality of Walsh code groups being generated by dividing the total 2N (N is a positive integer) Walsh codes by a number of 2^{M} (M<N, M is a positive integer). Here, the selected Walsh code group is used for frequency spreading. And, this exemplary embodiment of the present invention is described in detail on the assumption that N is 6, M is 4, and 64 Walsh codes are used.

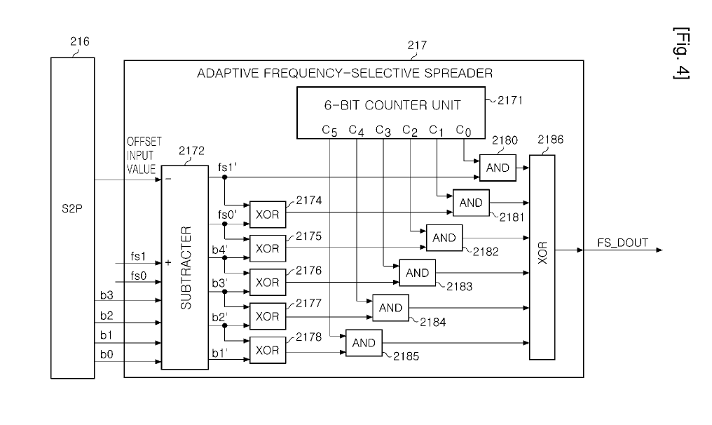

Referring to FIG. 3, the adaptive frequency-selective spreader 217 according to one exemplary embodiment of the present invention includes a 6-bit counter unit 2171, adaptive frequency baseband selector 2172 receiving offset input value, 2-bit frequency-selective control bits (fs1, fs0) and lower-4-bit data input bits (b3, b2, b1, b0) to adaptively select a frequency band of Walsh codes that will be used for data communications, a gray indexing unit 2173, an arithmetic logic unit 2179 and an output unit 2186 outputting one bit of FS_DOUT. The units are described in more detail with reference to FIG. 4.

Here, the 2-bit frequency-selective control bits (fs1, fs0) are set to different values according to the selected frequency bands. For example, 16 Walsh codes spanning from W0 to W15 are selected when the frequency-selective control bits (fs1, fs0) is (0, 0), 16 Walsh codes spanning from W16 to W31 are selected when the frequency-selective control bits (fs1, fs0) is (0, 1), 16 Walsh codes spanning from W32 to W47 are selected when the frequency-selective control bits (fs1, fs0) is (1, 0), and 16 Walsh codes spanning from W48 to W63 are selected when the frequency-selective control bits (fs1, fs0) is (1, 1).

Also, the adaptive frequency baseband selector 2172 may offset selection of indexes of the Walsh codes. Therefore, it is possible to select a frequency band of the Walsh codes by varying the 2-bit frequency-selective control bits (fs1, fs0) and the offset input value.

FIG. 4 is a detailed block diagram illustrating the adaptive frequency-selective spreader as shown in FIG. 3.

Referring to FIG. 4, the adaptive frequency baseband selector 2172 according to one exemplary embodiment of the present invention may offset selection of indexes of the Walsh codes using a subtracter. An output value of the subtracter is represented by the equation due to the offset input value: fs1fs0b3b2b1b0₍₂₎−offset input value=fs1′fs0′b3′b2′b1′b0′₍₂₎.

Also, the gray indexing unit 2173 requires 5 XOR logic circuits 2174, 2175, 2176, 2177 and 2178 for gray indexing, and the arithmetic logic unit 2179 is composed of 6 AND logic circuits 2180, 2181, 2182, 2183, 2184 and 2185 into which output values C₅˜C₀ of the 6-bit counter unit 2171 are inputted, respectively, and the most significant bits (fs1) of the frequency-selective control bits and 5 output bits of the 5 XOR logic circuits are also inputted, respectively. Also, the output unit 2186 is composed of one XOR logic circuit to perform an XOR operation on output values of the 6 AND logic circuits.

It is assumed that 16 Walsh codes (W₄₈ to W₆₃) of the 64 Walsh codes as shown in FIG. 2 are selected and used in the adaptive frequency-selective spreader 217 according to one exemplary embodiment of the present invention, 2-bit frequency-selective control bits (fs1, fs0) in 6-bit input bits are set to a bit value of 11 and an offset input value of the subtracter that may offset the indexes of the Walsh codes is set to a bit value of 0.

Therefore, the finally generated Output Equation of the adaptive frequency-selective spreader 217 is represented, as follows.

Output Equation=(fs1′ and C₀)xor[(fs1′ xor fs0′) and C₁]xor[(fs0′ xor b3′) and C₂]xor[(b3′ xor b2′) and C₃]xor[(b2′ xor b1′) and C₄]xor[(b1′ xor b0′) and C₅]

Also, the adaptive frequency-selective spreader 217 according to one exemplary embodiment of the present invention may select indexes of the Walsh codes by offsetting the indexes of the Walsh codes. For example, the selected indexes of the Walsh codes spans from 62 to 47 when the offset value is 1, that is, a value of the subtracter as shown in FIG. 4 is −1 while selecting fs0=1 and fs1=1.

Also, the Walsh codes used to adaptively select a frequency band of the Walsh codes may be used in the present invention when they are Walsh codes or bit-shifted codes of the Walsh codes, Walsh codes generated by performing a bit computing on AND, OR and XOR between the Walsh codes, or Walsh codes whose codes such as PN sequence may be divided with a sequence according to the frequency components.

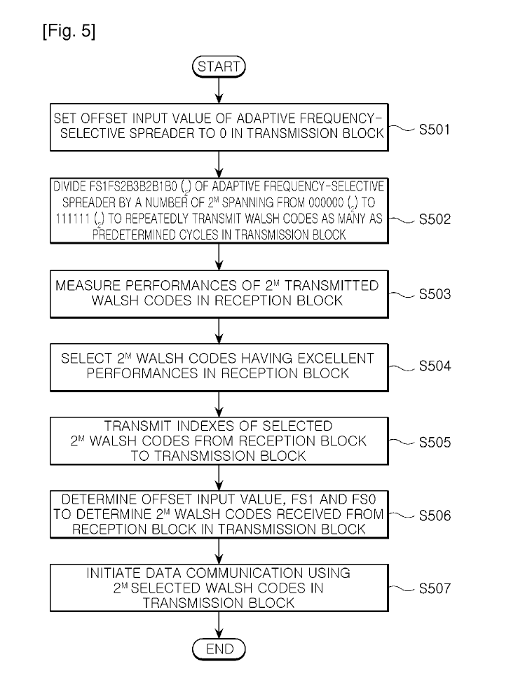

FIG. 5 is a flowchart illustrating a method for selecting a frequency band of Walsh codes that are the most suitable for data communications according to channel characteristics and noise environments, which may be applied to the frequency-selective baseband transmission system according to one exemplary embodiment of the present invention.

Referring to FIG. 5, when 64 Walsh codes are used as the Walsh codes and M data bits are used for data transmissions in the present invention, an offset input value of the adaptive frequency-selective spreader 217 in the transmitter 21 is first set to a bit value of 0 (S501), and a value of fs0fs1b3b2b1b0₍₂₎ is divided by a number of 2^{M} spanning from 000000₍₂₎ to 111111₍₂₎ (binary representation) to transmit Walsh codes (S502).

Also, indexes of each of 2^{M} Walsh codes represented by a decimal number, for example, 0˜2^{M}−1, 1˜2^{M}, 2˜2^{M}+1 . . . 63−2^{M}˜62, 64−2^{M}˜63. Also, the indexes of the Walsh codes may not be necessarily successive.

The 64/2^{M} (the rest number discarded) Walsh codes as a number of 2^{M} are repeatedly transmitted at such sufficient cycles that receiver 22 can determine the channel characteristics of the corresponding Walsh codes (S502). Assume that the receiver 22 senses that the transmitter 21 transmits the training signal.

The receiver 22 measures performances of the 64/2^{M} Walsh codes as a number of 2^{M} transmitted from the transmitter 21 (S503), and selects the 2^{M} Walsh codes having the most excellent performances (S504).

The performances of the Walsh codes are measured, for example, by using a bit error rate (BER) or a frame error rate (FER) as a measurement standard, and the Walsh codes having the lowest BER or FER value are selected.

Then, the receiver 22 transmits indexes (a start index or some or all indexes) of the selected Walsh codes to the transmitter 21 (S506).

The transmitter 21 receives the indexes of the Walsh codes transmitted from the receiver 22, and determines an offset input value and frequency-selective control bits (fs1, fs2) for determining 2^{M} Walsh codes with the corresponding indexes (S506).

When this procedure is completed, the data communication between the transmitter and the receiver is initiated using the 2^{M} selected Walsh codes that are considered to be the most suitable for the channel characteristics and the noise environments (S507). Also, this procedure may be periodically performed before/after the initiation of communications.

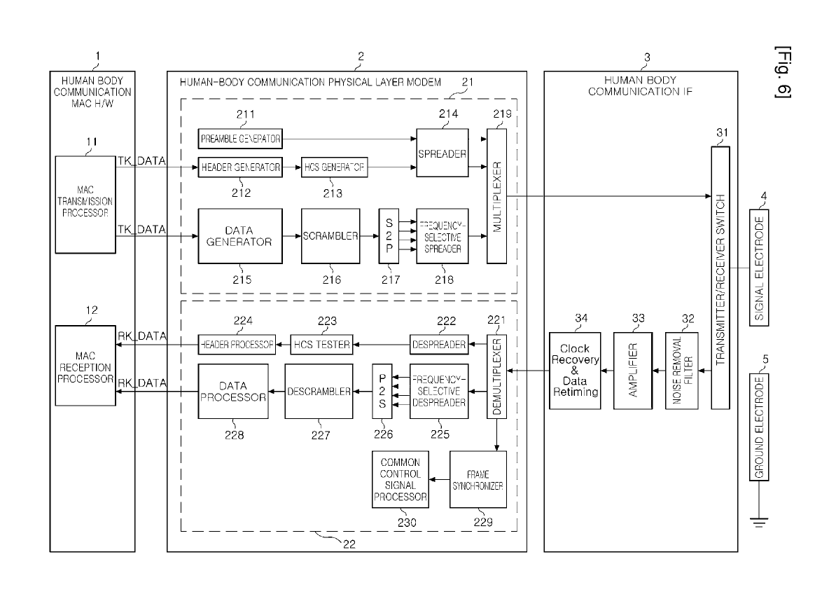

FIG. 6 shows a human-body communication transmitter/receiver according to one exemplary embodiment of the present invention when a bit value of 2^{M} is 16.

As shown in FIG. 6, the human-body communication system includes a human-body communication MAC H/W 1, a human-body communication physical layer modem (FS-CDMA) 2, a human-body communication IF 3, a signal electrode 4 and a ground electrode 5.

More particularly, an MAC transmission processor 11 in the human-body communication MAC H/W 1 processes data to be transmitted and information on the data that are received from an upper layer, and transmits the processed data and information on the data to a transmitter 21 in the human-body communication physical layer modem 2, and an MAC reception processor 12 functions to receive data and the information on the data that are received by the receiver 22 of the human-body communication physical layer modem 2, process the received data and the information on the received data, and transmit the processed data and the information on the processed data to the upper layer.

The human-body communication physical layer modem 2 includes a transmitter 21 and a receiver 22, both of which use a frequency-selective baseband.

The transmitter 21 includes a preamble generator 211, a header generator 212, a data generator 215, an HCS generator 213, a spreader 214, a scrambler 216, a serial-to-parallel converter (S2P) 217, an adaptive frequency-selective spreader 218 and a multiplexer 219.

The preamble generator 211 is set to an initial value that all users know. In this case, the preamble generator 211 generates a preamble having a predetermined length, inputs the generated preamble into the spreader 214. Then, the spreader 214 spreads the inputted preamble into appointed Walsh codes.

The header generator 212 receives data information (transmission rate, modulation method, user ID, data length) transmitted from the human-body communication MAC H/W 1, constructs the received data information into an appointed header format, and inputs the header format into the HCS generator 213 to generate HCS. Then, the generated HCS is inputted into the spreader 214, and spread into appointed Walsh codes.

The data generator 215 receives data transmitted from the MAC transmission processor 11, and outputs the received data at a desired point of time.

The scrambler 216 reset by the user ID outputs an orthogonal code. In this case, the data scrambling is completed by performing an XOR operation on the orthogonal code with an output bit value of the data generator 215.

When it is assumed that the serial-to-parallel converter 217 receives the scrambled data to construct 64 Walsh codes, a 4-bit serial-to-parallel conversion is performed.

A used frequency band is reduced by ¼ owing to the results of the serial-to-parallel conversion. This has an advantage in that high-quality data may be transmitted by transmitting more data within the same frequency band or using a lager Walsh code gain within the same frequency band.

The adaptive frequency-selective spreader 218 receives output 4 bits of the serial-to-parallel converter 217 in a parallel manner, and outputs adaptive frequency-selective Walsh codes.

The multiplexer 219 outputs a preamble, a header and data to correspond the frame construction. The use of the adaptive frequency-selective spreader makes it possible to permit a baseband transmission using a desired frequency band, and also to permit a direct digital transmission using an output bit as 1 bit.

Therefore, the output bits are inputted into a signal electrode 4 via a transmitter/receiver switch 31 without processing of the output bits in additional analog transmission blocks such as a digital-analog converter and an intermediate frequency converter, and then transmitted into a human body. A ground electrode 5 has the same baseline potential as a ground of the human-body communication transmitter/receiver.

An operation of a receiver 22 in the human-body communication physical layer modem 2 is performed, as follows. A received signal inputted through the signal electrode 4 is passed through a noise removal filter 32 in order to remove noises that are generated when the received signal is transmitted through the human body via the transmitter/receiver switch 31, and then amplified to a signal with a desired magnitude by the amplifier 33.

The amplified received signal is inputted into a clock recovery & data retiming unit (hereinafter, referred to as ‘CDR’) 34 to correct the timing synchronization of the received signal with a receiving-end clock and the frequency offset. The output bits of the CDR 34 are inputted into the receiver 22 of the human-body communication physical layer modem 2.

First, a received signal that has been inputted into the receiver 22 before the frame synchronization is inputted into a frame synchronizer 229 to perform a frame synchronization using a preamble.

When the frame synchronization is achieved by the frame synchronizer 229, a de-multiplexer 221 in the receiver 22 separates a header and data from the received signal, and outputs the separated header and data.

A header processor 224 extracts control information on the received signal data from the header which is transferred via a despreader 222 and a HCS tester 223, and transmits the extracted control information to the MAC reception processor 12.

The data out of the output bits of the demultiplexer 221 are inputted into an adaptive frequency-selective spreader 225, and a correlation value is calculated in a correlator (not shown) using 16 Walsh codes that are used in the transmitter 21 in a frequency-selective manner out of the 64 Walsh codes, and then the maximum data bit value of 4 bits are outputted.

The outputted 4 bits are inputted into a serial-parallel converter (P2S) 226, and converted into 4 parallel bits. Then, the converted 4 parallel bits are inputted into a de-scrambler 227, and descrambled into an orthogonal code that is outputted from an orthogonal code generator that is reset by the user ID extracted from the header. The de-scrambled received data are inputted into a data processor 228, processed and transmitted into the MAC reception processor 12.

Therefore, the present invention may be useful to have an effect to obtain a processing gain using the frequency-selective Walsh codes, and to simplify terminals of the analog transmitter and the analog receiver that are required for the pass band transmission, and thus to reduce consumption of an electric power by allowing a user to selectively use Walsh codes having a desired frequency band. Also, the present invention may be useful to improve an efficiency of the frequency spreading technology by adaptively changing a frequency spreading band according to the human body channel characteristics and the noise environments.

While the present invention has been described in connection with the exemplary embodiments, it will be apparent to those skilled in the art that modifications and variations can be made without departing from the spirit and scope of the invention as defined by the appended claims.

1. A method for selecting an adaptive frequency baseband of Walsh codes that are used for data communications in a human-body communication system, the method comprising:
setting an offset input value to 0;
generating a plurality of Walsh code groups by dividing the total 2^{N} Walsh codes used for frequency spreading by a number of 2^{M};
receiving (N−M) frequency-selective control bits to select one of a plurality of the Walsh code groups;
receiving M data bits and N counter bits to repeatedly transmit 2^{M} Walsh codes of the selected Walsh code group as many as predetermined cycles; and
receiving indexes of the selected 2^{M} Walsh codes by measuring performances of the respective 2^{M} Walsh codes in a plurality of the transmitted Walsh code groups.

2. The method of claim 1, wherein the performances of the transmitted 2^{M} Walsh codes are measured using a bit error rate (BER) or a frame error rate (FER).

3. The method of claim 1, wherein the indexes of the selected 2^{M} Walsh codes comprise either a start index, or some or all indexes.

4. An adaptive frequency-selective spreader using a frequency-selective baseband, comprising:
an N-bit counter unit outputting N counter bits;
an adaptive frequency baseband selector receiving M data bits, (N−M) frequency-selective control bits and offset input bits to select a desired frequency band;
a gray indexing unit gray-indexing the (N−M) frequency-selective control bits and the M data bits;
an arithmetic logic unit performing a logic arithmetic operation on the N counter bits and output bits of the gray indexing unit; and
an output unit receiving output bits of the arithmetic logic unit to select output bits.

5. The adaptive frequency-selective spreader of claim 4, wherein the adaptive frequency baseband selector is a subtracter for offsetting the indexes of the selected Walsh codes to select the desired frequency band.

6. The adaptive frequency-selective spreader of claim 5, wherein the gray indexing unit comprises (N−1) exclusive OR arithmetic operators (XOR).

7. The adaptive frequency-selective spreader of claim 6, wherein the arithmetic logic unit comprises each of N AND arithmetic operators (AND) inputting N counter bits, the most significant bits of (N−M) frequency-selective control bits, and output bits of the (N−1) exclusive OR arithmetic operators (XOR).

8. The adaptive frequency-selective spreader of claim 7, wherein the output unit comprises one exclusive OR arithmetic operator (XOR) inputting output bits of the N AND arithmetic operators (AND).

9. A transmitting apparatus for a human-body communication physical layer modem using an adaptive frequency-selective baseband, comprising:
a preamble and header generator generating a preamble for frame synchronization and a header including control information on data to be transmitted;
a data generator outputting the data to be transmitted as serial data;
a scrambler scrambling the serial data outputted from the data generator;
a serial-to-parallel converter converting the scrambled serial data into M parallel data bits and outputting the converted M parallel data bits;
an adaptive frequency-selective spreader selecting one of a plurality of Walsh code groups generated by dividing the total 2^{N} Walsh codes used for frequency spreading by a number of 2^{M}, and outputting 2^{M} Walsh codes of the selected Walsh code group; and
a multiplexer multiplexing the generated preamble, the header and the selected 2^{M} Walsh codes into digital signals and transmitting the multiplexed digital signals.

10. The transmitting apparatus of claim 9, wherein the transmitting apparatus periodically transmits pre-set Walsh codes between transmitting and receiving apparatuses to the receiving apparatus before or after the initiation of communication of data to determine channel characteristics and ambient noise environments in order to adaptively select a frequency band of the Walsh codes used for frequency spreading.

11. The transmitting apparatus of claim 10, wherein the transmitting apparatus repeatedly transmits the pre-set Walsh codes as many as predetermined cycles in order to determine the channel characteristics.

12. The transmitting apparatus of claim 9, wherein the adaptive frequency-selective spreader comprises:
an N-bit counter unit outputting N counter bits;
an adaptive frequency baseband selector receiving M data bits, (N−M) frequency-selective control bits and offset input bits to select a desired frequency band;
a gray indexing unit gray-indexing the (N−M) frequency-selective control bits and the M data bits;
an arithmetic logic unit performing an AND logic arithmetic operation on the N counter bits and output bits of the gray indexing unit; and
an output unit receiving output bits of the arithmetic logic unit to select output bits.

13. The transmitting apparatus of claim 9, wherein the preamble and header generator comprises:
a preamble generator set to an initial value to generate a preamble having a predetermined length, the initial value being set to acquire frame synchronization;
a header generator constructing a header having a pre-set header format, which includes the control information on data to be transmitted;
an HCS generator generating a header check sequence (HCS) using the control information having the header format; and
a spreader spreading the generated preamble and header.

14. A receiving apparatus for a human-body communication physical layer modem using an adaptive frequency-selective baseband, comprising:
a frame synchronizer detecting a preamble from the transmission data transmitted from a transmission block to perform frame synchronization;
a demultiplexer separating a header and data from the transmission data according to the frame synchronization and outputting the separated header and data;
a header processor dispreading the separated header, followed by restoring the control information on data through a header check sequence (HCS) testing;
an adaptive frequency-selective spreader calculating a correlation value between the separated data and Walsh codes in one Walsh code group, and determining index values of the Walsh codes having the highest correlation value to output corresponding M-bit parallel data, the one Walsh code group being selected from a plurality of Walsh code groups generated by dividing the total 2^{N} Walsh codes used for frequency spreading by a number of 2^{M}, and the Walsh codes in the one Walsh code group being used for spreading of the transmission block;
a parallel-to-serial converter converting the M-bit parallel data into serial data and outputting the converted serial data;
a descrambler descrambling the serial data into orthogonal codes; and
a data processor processing the descrambled data.

15. The receiving apparatus of claim 14, wherein the receiving apparatus periodically receives pre-set Walsh codes between transmitting and receiving apparatuses from the transmission block before or after initiation of the communication of data, and measures performances of the received Walsh codes to determine channel characteristics and ambient noise environments in order to adaptively select a frequency band of the Walsh codes used for frequency spreading.

16. The receiving apparatus of claim 15, wherein the receiving apparatus selects the Walsh codes that are most suitable for the channel characteristics and the ambient noise environments by measuring the performances of the received Walsh codes using a bit error rate (BER) or a frame error rate (FER).

17. The receiving apparatus of claim 16, wherein the receiving apparatus selects the Walsh codes that are most suitable for the channel characteristics and the ambient noise environments, and allots indexes to the selected Walsh codes to transmit either a start index, or some or all indexes to the transmission block.
